(19) United States
(12) Patent Application Publication
(10) Pub. No.: US 2005/0200607 A1
(43) Pub. Date: Sep. 15, 2005

(54) Keyboard with a switch-membrane assembly circuit-node support located in a cavity

(76) Inventors: Thomas S. Neal, Cupertino, CA (US); John Norman, San Jose, CA (US); Guillermo Andres, Plesanton, CA (US); Ray Gradwohl, Saratoga, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/800,281

(22) Filed: Mar. 12, 2004

(51) Int. Cl. G09G 5/00

(52) U.S. Cl. 345/168

(57) ABSTRACT

A lower enclosure of a keyboard includes a region forming a cavity to stiffen the lower enclosure and a node support disposed in the cavity to support a node of a circuit in a switch-membrane assembly of the keyboard. With the node support, a plate to support the switch-membrane assembly may be omitted from the keyboard. Thus, the keyboard may be easier and less expensive to manufacture than a keyboard that includes a plate.

### CROSS-REFERENCED APPLICATIONS

U.S. Design patent application Ser. No. ______, titled PANEL AND SPECIAL FUNCTION KEYS FOR KEYBOARD OR SIMILAR ARTICLE, attorney docket number 200314059-1 (1964-44-5), filed on 12 Mar. 2004, is herein incorporated by reference.

### BACKGROUND

Many computer systems include a processor that receives data and executes instructions, and a keyboard that is coupled to the processor and that allows one to provide data to the processor. The keyboard typically includes many circuits that, when closed individually or in combination with another circuit, generate a respective signal that provides the processor corresponding data. To close a circuit, one typically exerts pressure on a respective key of the keyboard.

FIG. 1 is an exploded view of a conventional keyboard 10, which includes a plurality of circuits 12 (only two reference numbers denoting one circuit shown for clarity) and a plate 14 to support the circuits when one or more of circuits are closed. The keyboard 10 also includes a plurality of keys 16 (only two shown for clarity) each corresponding to a respective circuit 12, an upper enclosure 18 to hold each key 16 and protect components inside the keyboard, and a lower enclosure 20 to support and protect components inside the keyboard. The lower enclosure 20 includes a cavity 21 for stiffening the lower enclosure and providing a passage for the cable 23 that couples the keyboard 10 to a processor (not shown). The keyboard 10 also includes a switch-membrane assembly 22 that includes the circuits 12. The switch-membrane assembly 22 includes a top sheet 24 having top portions 26 and top nodes 28 of each circuit 12, a bottom sheet 30 having bottom portions 32 and bottom nodes 34 of each circuit, and an insulating sheet 36 between the top and bottom sheets for insulating the top circuit portions from the bottom circuit portions. The insulating sheet 36 also includes a plurality of holes 38 (only one reference number shown for clarity), each corresponding to a respective set of nodes 28 and 34 for each circuit 12. The keyboard 10 also includes a plurality of elastic domes 40 (only one reference number shown for clarity), each corresponding to a respective key 16 to urge the key away from the switch-membrane assembly 22.

To close a circuit 12 of the switch-membrane assembly 22, one presses a corresponding key 16 to couple the top portion 28 of the circuit with the bottom portion 32 by causing the top node 28 to contact the bottom node 34. That is, to contact the top node 28 with the bottom node 34, one exerts pressure on the key 16, and thus the corresponding dome 40, to move the top node 28 through the hole 38 toward the bottom node 34. The plate 14 supports the bottom node 34 to help establish contact between the top node 28 and bottom node when the top node is moved through the hole 38. The support function of the plate 14 is especially important if the bottom node 34 is located above the cavity 21. Without some support, the bottom node 34 would move into the cavity 21 when the top node 28 is moved toward it, and thus the top node may not contact the bottom node to generate a signal. To re-open the circuit 12, one removes the pressure exerted on the key 16 to allow the elastic dome 40 to urge the key 16 away from the top node 28, and thus allow the top node to move away from and out of contact with the bottom node 34.

Unfortunately, manufacturing the keyboard 10 can be complex and expensive. The plate 14 is typically made of metal and sized to match the area of the switch-membrane assembly 22 to provide the keyboard 10 a desired stiffness during use. In addition, the plate 14 must be located in the keyboard 10 to complete the keyboard's assembly. Consequently, the cost to manufacture the keyboard 10 includes the cost of the labor and material used to make the plate 14 and the cost of the labor used to install the plate in the keyboard.

### SUMMARY

In one aspect of the invention, a keyboard enclosure includes a region forming a cavity to stiffen the lower enclosure and a node support located in the cavity to support a node of a circuit in a switch-membrane assembly of the keyboard. With the node support, a plate to support the switch-membrane assembly may be omitted from the keyboard. Thus, the keyboard may be easier and less expensive to manufacture than a conventional keyboard.

### BRIEF DESCRIPTION OF THE FIGURES

FIG. 1 is an exploded view of a conventional keyboard.

FIG. 2 is an exploded view of a keyboard incorporating a lower enclosure according to an embodiment of the invention.

FIG. 3 is a plan view of the lower enclosure of FIG. 2.

FIG. 4 is a side view of the keyboard of FIG. 2.

FIG. 5 is a block diagram of an electronic system that includes the keyboard of FIGS. 2 and 4.

### DETAILED DESCRIPTION

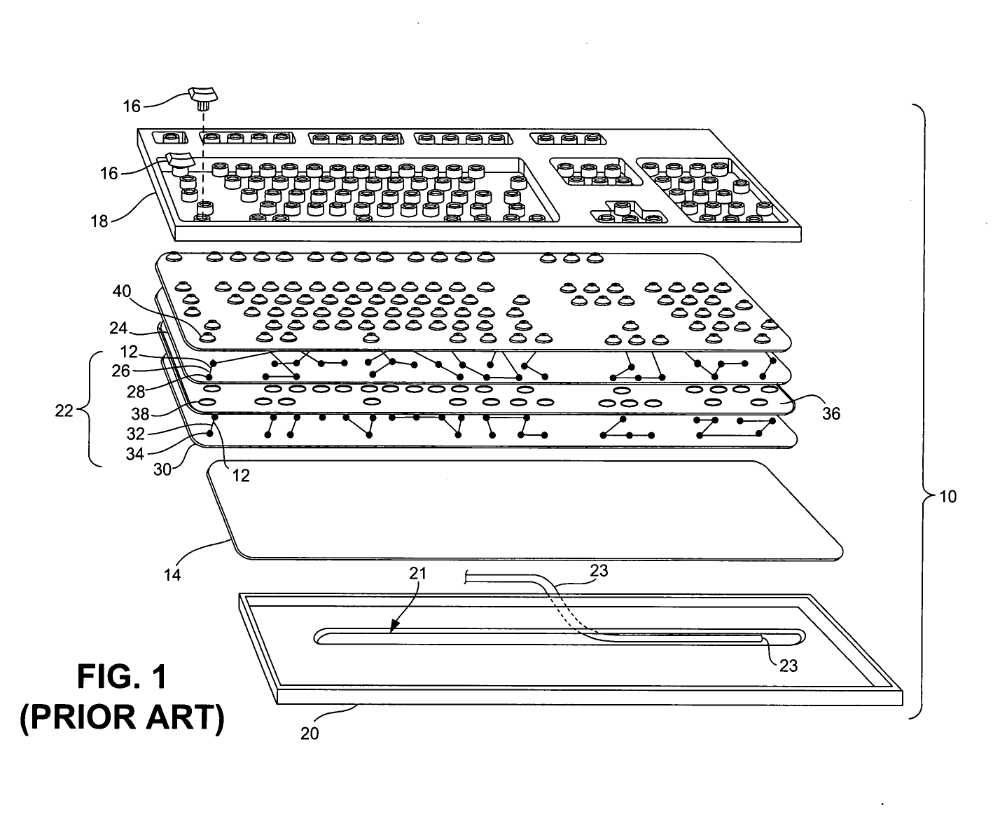

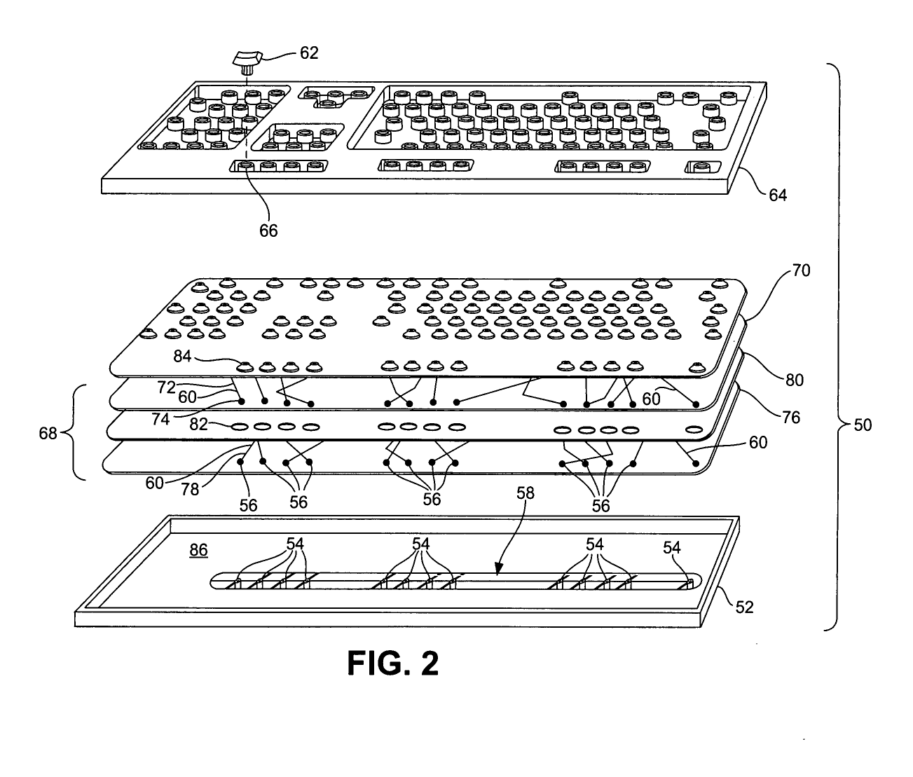

FIG. 2 is an exploded view of a keyboard 50 that includes a lower enclosure 52 having node supports 54, according to an embodiment of the invention. The keyboard 50 may be used to provide data to a processor (not shown) for performing various computing functions, such as executing programs to perform specific tasks. Each node support 54 supports a respective circuit node 56 that is located above a cavity 58 formed in the lower enclosure 52. Each circuit node 56 is a component of a respective one of a plurality of circuits 60 (only four reference numbers shown for clarity) in the keyboard 50 that may generate a signal to provide the processor data as discussed below. Because the node support 54 can support the circuit nodes 56, the keyboard 50 does not require a plate (e.g., 14 in FIG. 1) to support the circuit nodes located above the cavity 58.

The keyboard 50 also includes a plurality of keys 62 (only one shown for clarity), each corresponding to a respective circuit 60, and an upper enclosure 64 that includes a plurality of key receptacles 66 (only one reference number shown for clarity) each to hold a respective key 62. The keyboard 50 also includes a switch-membrane assembly 68 that includes the plurality of circuits 60. The switch-membrane assembly 68 includes a top sheet 70 having a top portion 72 and a top node 74 of each circuit 60, a bottom sheet 76 having a bottom portion 78 and a bottom node 56 of each circuit 60, and an insulating sheet 80 between the top and bottom portions. The insulating sheet 80 also includes holes 82 (only one reference number shown for clarity), each corresponding to a respective set of top and bottom nodes for each circuit 60. The keyboard 50 also includes a plurality of elastic domes 84 (only one reference number shown for clarity), each corresponding to a respective key 62 and operable to bias the key 62 away from the switch-membrane assembly 68.

In operation, when one presses a key 60, the corresponding circuit 60 in the keyboard 50 generates a respective signal to provide the corresponding data (e.g., an ASCII character such as “A”) to the processor (not shown). That is, when a circuit 60 is closed, it generates a signal, and when a circuit 60 is open, it does not generate a signal. To close a circuit 60, one exerts pressure on the key 62 that corresponds to the circuit to contact the circuit's respective bottom node 56 with the top node 74. If the bottom node 56 is located above the cavity 58, then a respective node support 54 supports the bottom node to help ensure contact between the top and bottom nodes 74 and 56, respectively, is maintained while the circuit 60 generates the signal. If the bottom node 56 of the circuit is not located above the cavity 58, then the floor 86 of the lower enclosure 52 may support the bottom node 56 while the circuit 60 generates the signal. To open the circuit 60, one removes the pressure from the key 62 to allow a respective elastic dome 84 to move the key away from the switch membrane 68, and thus, the top node 74 moves away from the bottom node 56 to break the contact between the top and bottom nodes.

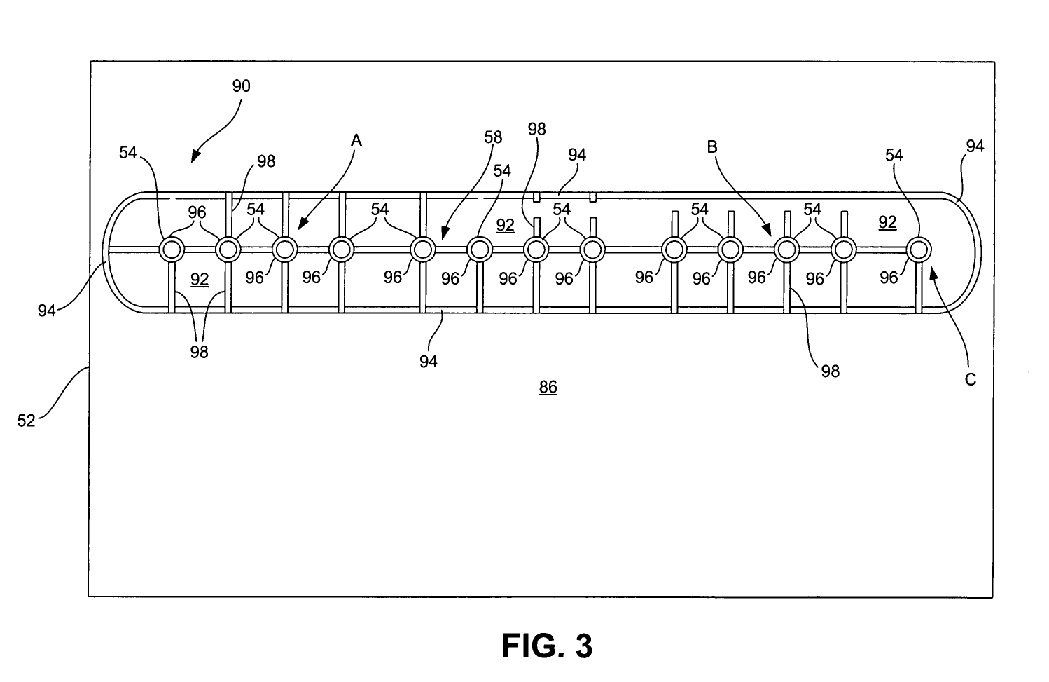

FIG. 3 is a top view of the lower enclosure 52 in FIG. 2. The lower enclosure 52 includes a region 90 that forms the cavity 58 and that stiffens the lower enclosure, and node supports 54 disposed in the cavity to support the bottom nodes 56 (FIG. 2) that are located above the cavity. Although FIG. 3. shows the lower enclosure 52 including one region 90 that forms a cavity 58, the lower enclosure may include two or more regions 90 as desired to stiffen the lower enclosure and/or to provide node supports 54 for corresponding bottom nodes 56 or to provide room for other components (not shown) of the keyboard 50 (FIG. 2). Furthermore, the region 90 of the lower enclosure 52 may include two or more cavities 58 as desired to stiffen the lower enclosure, or to provide node supports 54 for corresponding bottom nodes 56, or to provide room for other components of the keyboard 50.

The cavity 58 may have any desired shape. For example, in one embodiment the cavity 58 may have a substantially U-shaped cross-section. In another embodiment, the cavity 58 extends approximately 15.5 inches across the floor 86 of the lower enclosure 52 and includes a bottom wall 92 and a sidewall 94. In this embodiment, the sidewall 94 extends approximately 0.5 inches between the floor 86 and the bottom wall 92, and thus provides an approximate cavity depth of 0.5 inches.

Other embodiments are contemplated. For example, the cavity 58 may have a substantially W-shaped cross-section and, when viewed from above may curve across the floor 86. For example, when viewed from above, the cavity 58 may form an S, a circular or elliptical arc, or any other such curve.

Still referring to FIG. 3, the lower enclosure 52 may include any number of node supports 54, and each node support may be located anywhere in the cavity 58 to correspond to a respective circuit node 56 (FIG. 2) that is located above the cavity. Furthermore, each node support 54 may be shaped as desired to support the circuit node 56. For example, in one embodiment the lower enclosure 52 may include thirteen node supports 54 and each node support 54 may be cylindrically shaped and hollow. Each node support 54 may also extend from the bottom wall 92 toward the floor 86 of the lower enclosure 52, and include an end 96 that is substantially level with the floor 86. Thus, the bottom sheet 76 (FIG. 2) typically lies substantially flat when supported by the lower enclosure 52, and remains substantially flat when the key 62 (FIG. 1) urges a top node 74 (FIG. 1) to contact a bottom node 56 that is located above the cavity 58.

Other embodiments are contemplated. For example, the lower enclosure 52 may include more or fewer node supports 54, and one or more of the node supports 54 may be square shaped, solid and extend from a sidewall 94 of the region 90. Furthermore, one or more of the node supports 54 may extend from the bottom wall 92 or sidewall 94 to locate the end 96 above or below the floor 86 of the lower enclosure 52. This may be desirable when other components of the keyboard 50 are located between the bottom sheet 76 and the floor 86.

Still referring to FIG. 3, the lower enclosure may also include ribs 98 to support the node supports 54 and maintain the position of the node supports 54 relative to the floor 86. Each rib 98 may extend from a node support 54 toward another node support 54 and/or the bottom wall 92 and/or the sidewall 94. For example, in one embodiment four ribs 98 may support one of the node supports 54 (see A in FIG. 3). Two of the ribs 98 may extend between the sidewall 94, the bottom wall 92 and the node support 54; and the other two ribs 98 may extend between the node support 54, adjacent node supports 54, and the bottom wall 92. Another node support 54 (see B in FIG. 3) may be supported by four ribs 98 with one of the ribs 98 extending between the bottom wall 92 and the node support 54; not the sidewall 94 or other node supports 54. And yet another node support 54 (see C in FIG. 3) may be supported by two ribs 98 with one of the ribs 98 extending between the node support 54, the bottom wall 92 and the sidewall 94, and the other rib 98 extending between the node support 54, an adjacent node support 54 and the bottom wall 92.

Still referring to FIG. 3, the lower enclosure 52 may be made from any desirable material using any desired manufacturing process. For example, in one embodiment the lower enclosure 52 may be made of conventional plastic and cast as one piece from a mold. Thus, the node supports 54 and ribs 98 may be an integral part of the formed lower enclosure 52. In other embodiments, the node supports 54 and ribs 98 may be fastened to the lower enclosure 52 using any desired means, such as gluing with an adhesive.

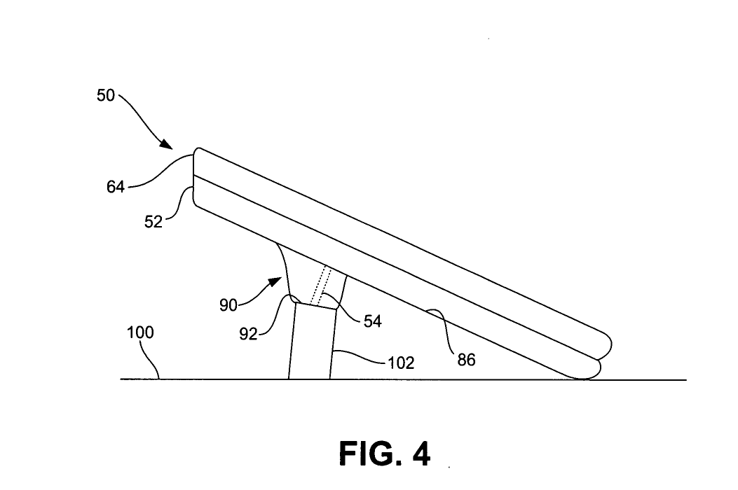

FIG. 4 is a side view of the keyboard in FIG. 2 assembled and positioned on a surface 100, according to an embodiment of the invention. When the keyboard 50 is assembled, the upper enclosure 64 may be mounted to the lower enclosure 52 to protect the switch-membrane assembly 68 (FIG. 2), elastic domes 84 (FIG. 2) and other components of the keyboard 50 that may be located between the upper and lower enclosures 64 and 52, respectively. To position the keyboard 50 on the surface 100 as shown, the lower enclosure 52 may include a leg 102 that may be extended from the region 90. For example, in one embodiment the leg 102 may contact the surface 100 at a substantially perpendicular angle. Furthermore, the region 90 may be formed to position the bottom wall 92 substantially parallel to the surface 100 when the keyboard 50 is positioned as shown. Thus, each node support 54 may be angled relative to the bottom wall 92 so that each node support's end 96 (FIG. 3) remains substantially parallel with the floor 86.

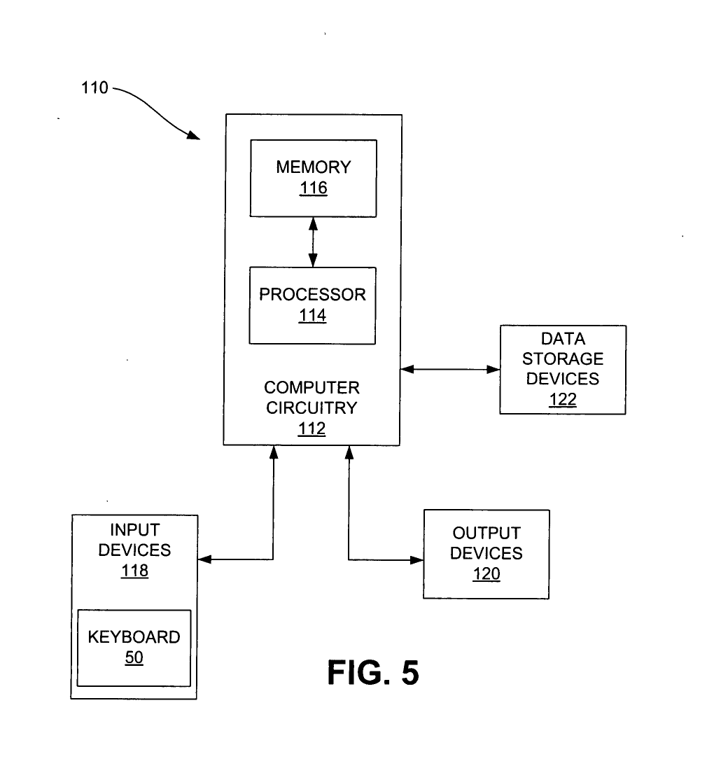

FIG. 5 is a block diagram of an electronic system 110 that incorporates the keyboard 50 (FIGS. 2 and 4). The system 110 includes computer circuitry 112, which includes a processor 114 and a memory 116 coupled to the processor, for performing computer functions such as executing software to perform desired calculations and tasks. One or more input devices 118 that includes the keyboard 50 and may include other devices such as a mouse or microphone, are coupled to the computer circuitry 112 and allow an operator (not shown) to input data thereto. One or more output devices 120 are coupled to the computer circuitry 112 to provide to the operator data generated by the computer circuitry 112. Examples of such output devices 120 include a printer and a video display unit. One or more data-storage devices 122 are coupled to the computer circuitry 112 to store data on or to retrieve data from external storage media (not shown). Examples of such storage devices 122 and the corresponding storage media include drives that accept hard and floppy disks, tape cassettes, and compact disk read-only memories (CD ROMS).

The preceding discussion is presented to enable one skilled in the art to make and use the invention. Various modifications to the disclosed embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

1. A keyboard enclosure comprising:
a region forming a cavity; and
a node support located in the cavity and operable to support a node of a switch membrane assembly.

2. The enclosure of claim 1 wherein the enclosure includes one cavity.

3. The enclosure of claim 1 wherein the cavity has a substantial U-shape.

4. The enclosure of claim 1 wherein the cavity has a substantial U-shape and extends substantially 15.5 inches.

5. The enclosure of claim 1 wherein the cavity has a substantial U-shape, extends substantially 15.5 inches, and is substantially 0.5 inches deep.

6. The enclosure of claim 1 wherein the enclosure includes thirteen node supports, each disposed in the cavity.

7. The enclosure of claim 1 wherein the node support has a cylindrical shape.

8. The enclosure of claim 7 wherein the node support is hollow.

9. The enclosure of claim 1 wherein the cavity has a substantial U-shape and a bottom wall, and the node support extends from the bottom wall.

10. The enclosure of claim 1 wherein the node support includes an end located at an entrance of the cavity.

11. The enclosure of claim 1 wherein the enclosure includes a floor and a rib to maintain the position of the node support relative to the floor.

12. The enclosure of claim 11 wherein the enclosure includes at least two ribs each operable to maintain the position of the node support relative to the floor.

13. The enclosure of claim 12 wherein the enclosure includes at least two node supports, and one of the ribs extends between two node supports.

14. The enclosure of claim 11 wherein:
the cavity has a substantial U-shape, a bottom wall, and a sidewall,
the node support extends from the bottom wall, and
the enclosure includes at least two ribs that extend between the node support and at least one side wall.

15. A keyboard comprising:
a plurality of keys, each movable relative to the other keys;
a switch membrane assembly including a plurality of circuits each having a node corresponding to a respective key, wherein each circuit is operable to generate a signal when a key corresponding to the circuit's node is moved relative to the node;
an upper enclosure to hold the keys; and
a lower enclosure to support the switch membrane assembly, the lower enclosure including:
a region forming a cavity and operable to stiffen the lower enclosure, and
a node support located in the cavity and operable to support a node of the switch membrane assembly.

16. The keyboard of claim 15 wherein the lower enclosure includes thirteen node supports, each operable to support a respective node of the switch membrane assembly.

17. The keyboard of claim 15 wherein:
the lower enclosure includes two legs operable to support a portion of the lower enclosure above a surface, and
the region extends between the two legs.

18. The keyboard of claim 15 wherein the lower enclosure includes a rib operable to maintain the position of the node support relative to the node of the switch membrane assembly.

19. A computer system comprising:
computer circuitry for performing computer functions; and
a keyboard operable to provide data to the circuitry and including:
a plurality of keys, each movable relative to the other keys,
a switch membrane assembly including a plurality of circuits each having a node corresponding to a respective key, wherein each circuit is operable to generate a signal when a key corresponding to the circuit's node is moved relative to the node,
an upper enclosure to hold the keys, and
a lower enclosure to support the switch membrane assembly, the lower enclosure including:
a region forming a cavity, and
a node support located in the cavity and operable to support a node of the switch membrane assembly.

20. A method for supporting a switch membrane assembly of a keyboard, comprising:
forming a cavity in a region of a lower enclosure of a keyboard to stiffen the lower enclosure;
locating a node support in the cavity to support a circuit node of the switch membrane assembly.

21. The method of claim 20 further comprising locating a rib in the cavity to maintain the position of the node support relative to a floor of the lower enclosure.

22. The method of claim 21 wherein locating the rib includes extending the rib between the node support and a wall of the cavity.

23. The method of claim 21 wherein locating the rib includes extending the rib between two node supports.

24. A method for generating a signal, the method comprising:
moving a key of a keyboard to move a top node of a switch membrane assembly toward a corresponding bottom node of the assembly;
contacting the bottom node with the top node to generate a signal; and
supporting the bottom node with a node support when the top node contacts the bottom node.

25. The method of claim 24 wherein moving the key of the keyboard includes pushing the key toward the top node.
